(19) United States
(12) Patent Application Publication
(10) Pub. No.: US 2020/0145459 A1
(43) Pub. Date: May 7, 2020

(54) CENTRALIZED AUTHENTICATION AND AUTHORIZATION

(71) Applicant: INTUIT INC., Mountain View, CA (US)

(72) Inventors: Kevin FEUTZ, Sunnyvale, CA (US); Eugene GOLOVINSKY, Palo Alto, CA (US); Gleb KESELMAN, Modiin (IL); Yaron LEVY, Sunnyvale, CA (US); Yaron SHEFFER, Hod HaSharon (IL)

(73) Assignee: INTUIT INC., Mountain View, CA (US)

(21) Appl. No.: 16/177,466

(22) Filed: Nov. 1, 2018

(51) Int. Cl. H04L 29/06

(52) U.S. Cl. CPC H04L 63/20; H04L 63/062; H04L 63/102; H04L 63/0892

(57) ABSTRACT

A processor of a central authority separate from a client and a service provider may receive an access request from the client. The access request may identify at least one of a client user and a client process. The processor may evaluate the access request to determine that the at least one of the client user and the client process complies with an access policy for the service provider. In response to determining that the at least one of the client user and the client process complies with the access policy, the processor may generate a credential including a key. The processor may send the credential to the client. The processor may receive the credential from the service provider. The processor may validate the key included in the credential. In response to the validating, the processor may cause the service provider to provide the client with access to the service.

### BRIEF DESCRIPTION OF THE FIGURES

FIG. 1 shows an authentication system according to an embodiment of the present disclosure.

FIG. 2 shows a computing device according to an embodiment of the present disclosure.

FIG. 3A shows a setup portion of an authentication and authorization process according to an embodiment of the present disclosure.

FIG. 3B shows a runtime portion of an authentication and authorization process according to an embodiment of the present disclosure.

FIG. 4 shows a policy definition user interface according to an embodiment of the present disclosure.

FIG. 5 shows a client setup and registration process according to an embodiment of the present disclosure.

### DETAILED DESCRIPTION OF SEVERAL EMBODIMENTS

Computing services may provide access to clients based on permissions. For example, services may be provided to client machines through one or more networks and/or internally within the machines themselves. In some cases, services may be provided to client machines on a process and/or user level basis. In order to consume a service, the client machine, process, and/or user may be authenticated to confirm its identity and may be authorized to confirm that it meets applicable policy requirements and can be granted access.

Client machines, processes, and/or users may access a variety of services. Each service can implement authentication and authorization mechanisms on its own. However, in this case, each service may require its own logic for determining which machines, processes, and/or users should be granted access. Moreover, each service may have its own policy for determining who should be granted access, and these policies may be configured and controlled separately from policies of other services.

Some embodiments described herein may provide a service ecosystem with centralized elements that may perform authentication and/or authorization for a plurality of separate services. Centralized authentication and/or authorization from a trusted authority may control access to any service registered with the authority. Accordingly, authentication and/or authorization logic may be performed efficiently by a single service, which may apply policies to a plurality of services and/or for different machines, processes, and/or users. Embodiments disclosed herein may expand the authentication paradigm by abstracting individual client machine (or process/client) identities to a set of restrictions the identities may match to be considered as authenticated.

As described in detail below, a service may register with the central authority, which may allow the central authority to perform authentication for clients of the service. After registration, the service may add access policies to the central authority. A client machine (or process or user, in some cases) may be authenticated based on access policy criteria, for example by the central authority checking that the client machine matches all criteria. The client machine may not have to be a single machine, and it may be possible that several machines in a fleet may match the criteria. Each access policy may have a unique access policy ID (authentication ID) which may be distributed to client machines. When a client machine attempts to access a service, the client machine may send a request to the central authority with information required by the corresponding access policy. If a client machine complies with the access policy, it may obtain temporary credentials which may be signed by the central authority. In every request to the service, the client machine may be required to include these temporary credentials. The service may validate temporary credentials by fetching a verification key from the central authority and/or by sending a validation request together with the temporary credentials to the central authority.

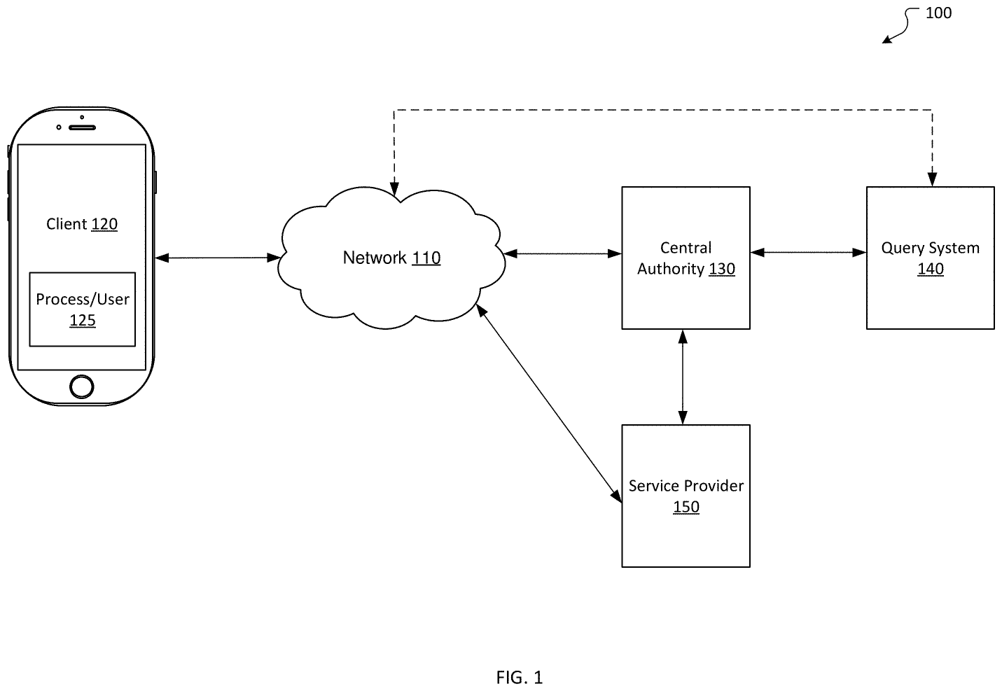

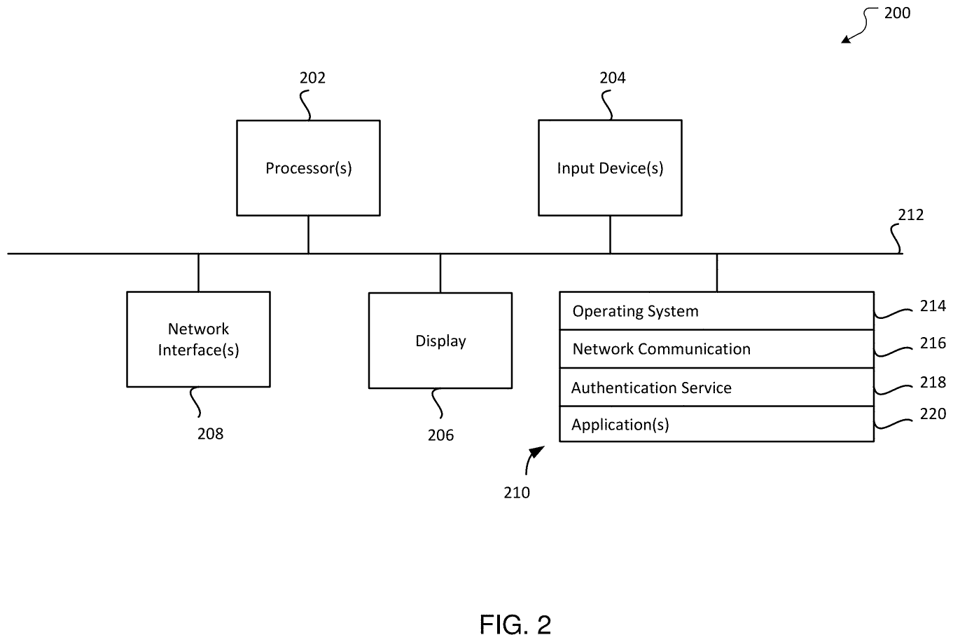

FIG. 1 shows an authentication system according to an embodiment of the present disclosure. System 100 may include elements such as at least one client 120, central authority 130, query system 140, and/or at least one service provider 150. Each of these elements may include one or more physical computing devices (e.g., which may be configured as shown in FIG. 2). In some embodiments, one physical computing device may provide at least two of the elements, for example central authority 140 and query system 150 may be provided by a single computing device. In some embodiments, one or more service providers 150 may be provided by the same computing device and/or the same device that provides central authority 140 and/or query system 150. In some embodiments, client 120 and service provider 150 may be provided by a single computing device. In some embodiments, client 120 may be any device configured to provide access to services. For example, client 120 may be a smartphone, personal computer, tablet, laptop computer, or other device. In some embodiments, service provider 150 may be any device configured to host a service, such as a server or other device or group of devices. In some embodiments, client 120 may be a service running on a device, and may consume other services as a client of those services (e.g., as a client of other service instances, virtual machines, and/or servers).

The elements may communicate with one another through at least one network 110. Network 110 may be the Internet and/or other public or private networks or combinations thereof. For example, in some embodiments, at least data central authority 130, query system 140, and/or at least one service provider 150 may communicate with one another over secure channels (e.g., one or more TLS/SSL channels). In some embodiments, communication between at least some of the elements of system 100 may be facilitated by one or more application programming interfaces (APIs). APIs of system 100 may be proprietary and/or may be examples available to those of ordinary skill in the art such as Amazon® Web Services (AWS) APIs or the like.

Specific examples of the processing performed by the elements of system 100 in combination with one another are given below. However, the roles of client 120, central authority 130, query system 140, and service provider 150 may be summarized as follows. Client 120 may attempt to access a service provided by service provider 150. The access may require authentication and/or authorization of client 120 at a device level or at a specific client process and/or user (e.g., process/user 125) level. Central authority 130 may perform authentication and/or authorization of client(s) 120 (and/or client process/user 125) for service provider(s) 150 registered with central authority 130, as described below. In some embodiments, central authority 130 may use query system 140 to gather data used in the authentication and/or authorization, as described below.

Client 120, central authority 130, query system 140, and service provider 150 are each depicted as single devices for ease of illustration, but those of ordinary skill in the art will appreciate that client 120, central authority 130, query system 140, and/or service provider 150 may be embodied in different forms for different implementations. For example, any of client 120, central authority 130, query system 140, and/or service provider 150 may include a plurality of devices, may be embodied in a single device or device cluster, and/or subsets thereof may be embodied in a single device or device cluster. In another example, a plurality of clients 120 and/or a plurality of service providers 150 may be connected to network 110 and may have their authorizations/authentications managed centrally as described herein. A single user may have multiple clients 120, and/or there may be multiple users each having their own client(s) 120. Client(s) 120 may each be associated with a single process 125, a single user 125, or multiple users and/or processes 125. Furthermore, as noted above, network 110 may be a single network or a combination of networks, which may or may not all use similar communication protocols and/or techniques.

FIG. 2 is a block diagram of an example computing device 200 that may implement various features and processes as described herein. For example, computing device 200 may function as client 120, central authority 130, query system 140, service provider 150, or a portion or combination of any of these elements. In some embodiments, a single computing device 200 or cluster of computing devices 200 may provide each of central authority 130, query system 140, service provider 150, or a combination of two or more of these services. Computing device 200 may be implemented on any electronic device that runs software applications derived from instructions, including without limitation personal computers, servers, smart phones, media players, electronic tablets, game consoles, email devices, etc. In some implementations, computing device 200 may include one or more processors 202, one or more input devices 204, one or more display devices 206, one or more network interfaces 208, and one or more computer-readable mediums 210. Each of these components may be coupled by bus 212, and in some embodiments, these components may be distributed across multiple physical locations and coupled by a network.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Authentication service instructions 218 may include instructions that perform the various authentication functions as described herein. Authentication service instructions 218 may vary depending on whether computing device 200 is functioning as client 120, central authority 130, query system 140, service provider 150, or a combination thereof.

Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other, or by processes running on the same device and/or device cluster, with the processes having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

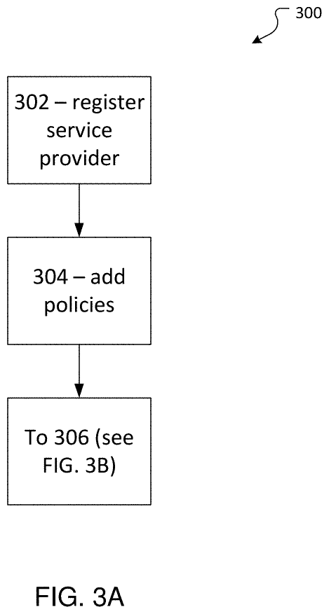

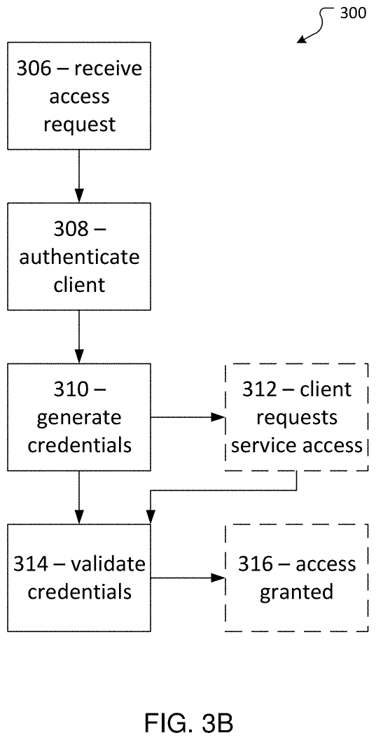

FIGS. 3A-3B show an authentication and authorization process 300 according to an embodiment of the present disclosure. For example, central authority 130 may perform process 300, alone or in conjunction with query system 140 and/or service provider 150, to allow client 120 or a specific process/user 125 thereof to access a service supplied by service provider 150.

FIG. 3A shows a setup portion of process 300. At 302, central authority 130 may register service provider 150 and/or one or more specific services provided by service provider 150. In some embodiments, in order for a service to use central authority 130 to maintain access permissions for clients 120, the service should register with central authority 130 first. In some embodiments, registration may be performed between central authority 130 and service provider 150 through secure shell (SSH) or other secure communication. For example, an administrator with SSH access may log into central authority 130 from service provider 150 to register service provider 150. Central authority 130 may register the service according to an asymmetric key policy, for example including sending a private key to service provider 150 and maintaining a corresponding public key stored in memory at central authority 130. Accordingly, during future access attempts by service provider 150, service provider 150 may send a message generated using the private key, and central authority 130 may authenticate the message using the corresponding public key. Central authority 130 may register the service in other ways in other embodiments. For example, central authority 130 may use any trusted entity to register the service, such as by a user interface after authenticating the user as a trusted administrator, through an API using a trusted administrator policy and/or key, or any other trusted methodology. In some embodiments, the registration may specify whether service provider 150 may be accessed according to a single policy or multiple policies (e.g., separate policies for different clients 120 and/or processes and/or users 125).

At 304, central authority 130 may add one or more access policies for service provider 150 registered at 302. An access policy may define one or more rules with which a machine, user, or process requesting authentication may be required to comply. Central authority 130 may support multiple types of access policies. For example, one access policy type may utilize asymmetric keys, and another access policy type may utilize one or more AWS policies (roles). As described below, techniques used to verify compliance with the rules of an access policy may vary in some embodiments.

For example, in order for a client 120 to access an API, the client may need an authentication credential known as an API key. Client 120 may be required to conform to an API access policy in order to get the API key directly from central authority 130. The policy may include a set of rules defining one or more characteristics client 120 may require in order to be eligible to receive the key. The policy may be any set of rules and/or properties that must be met by client 120 and may be cloud specific and/or cloud agnostic. For example, a policy may include rules related to an IP address and/or universal unique identifier (UUID) of client 120. In another example, a policy may include rules related to specific AWS properties required of client 120, such as an IAM role for client 120, a specific auto scaling group to which client 120 is required to belong, a specific subnet to which client 120 is required to belong, etc.

When service provider 150 adds its access policies, it may first authenticate with central authority 130 using its private key. The access policy may include service proprietary data which may be transparent to central authority 130 and which may be available to service provider 150 at subsequent portions of process 300 as described below. In addition to adding access policies to central authority 130, service provider 150 may distribute an access policy ID to clients 120.

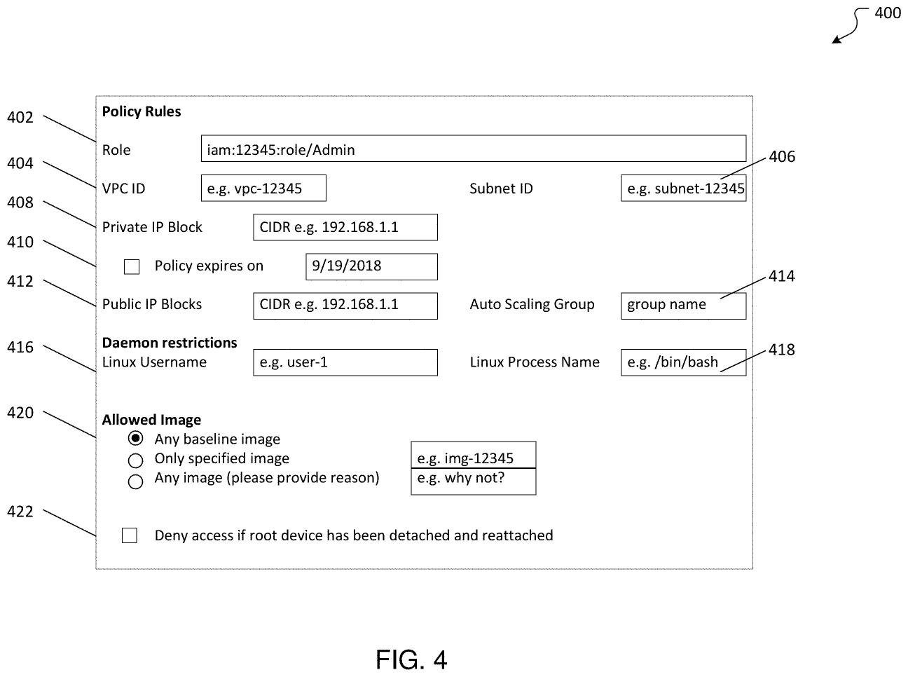

In some examples, a user may enter policy rules using an interface such as that shown in FIG. 4. FIG. 4 shows a policy definition user interface 400 according to an embodiment of the present disclosure. User interface 400 may be provided by service provider 150 locally and/or by service provider 150 accessing data hosted by central authority 130. User interface 400 may include one or more controls for specifying policy rules. The example user interface 400 of FIG. 4 includes several examples of policy rules that may be set with user interface 400. For example, policy rules may include, but are not limited to, IAM role (e.g., specified with an Amazon resource name (ARN)) 402, virtual private cloud (VPC) endpoint 404, subnet ID 406, private IP block 408, policy expiration time/date 410, public IP block 412, auto scaling group 414, username for user-specific policy 416, process name for process-specific policy 418, machine image for device-specific policy 420, and/or requirement for device attachment 422. Other embodiments may omit some of these controls and/or may add other controls not shown in FIG. 4.

As illustrated in FIG. 4, policies may be defined at a client 120 level or at a process and/or user 125 level. In some embodiments, if no user and no process are defined, central authority 130 may treat all users and all processes for an authorized client 120 as authorized. In some embodiments, once any user is configured, all other users may be treated as unauthorized. In some embodiments, once any process (e.g., executable, fullpath) is configured, all other processes may be treated as unauthorized. If only processes are defined but no users are defined, all users may be treated as authorized. Likewise, if only users are defined but no processes are defined, all processes may be treated as authorized. However, if both users and processes are defined, only a correct combination of both user and process may be authorized.

Central authority 130 may receive policies from service provider 150 and store the policies in a local database. For example, central authority 130 may store one or more Javascript Object Notation (JSON) elements defining the policy for a given service, which may include specific authorized username and/or process name data if specific users and/or processes have been defined as described above. Central authority 130 may store keys (e.g., HMAC keys) associated with authorized clients, users, and/or processes for given policies for performing authentication as described below, for example.

FIG. 3B shows a runtime portion of process 300. While the setup portion (302 and 304) may be performed to establish a registration and a policy for service provider 150, once the service provider 150 has been registered and has provided a policy, the setup portion may need not be repeated. In some cases, 304 may be repeated to change a policy applicable to service provider 150. On the other hand, the following runtime elements of process 300 may be repeated whenever client 120 attempts to access a service provided by service provider 150.

At 306, central authority 130 may receive an access request from client 120 for a service provided by service provider 150. For example, whenever client 120 wants to access the service, it may send a request to central authority 130 with policy ID and parameters required by the policy for the service. In some embodiments, the request may include a predefined string with time and/or nonce signed by private key for authentication using the asymmetric key policy. In some embodiments, the request may include an AWS identity document with signature and/or pre-signed caller identity URL for authentication using the AWS access policy.

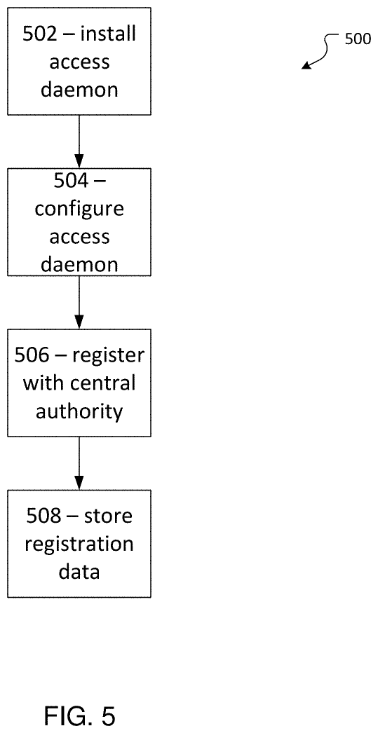

Sending a request with a predefined string and/or AWS identity document may be adequate for enforcement of policies that control access on a client 120 machine level. In some embodiments, such as when the policy controls access on a process and/or user 125 level, so that a given client 120 may or may not be able to access the service depending on which process and/or user 125 is attempting the access, additional client 120 processing may be applied. For example, FIG. 5 shows a client setup and registration process 500 according to an embodiment of the present disclosure. Client 120 may perform process 500 to prepare for process and/or user 125 level access to services provided by service provider(s) 150 in some embodiments.

At 502, client 120 may install an access daemon that may be configured to interface with central authority 130 through network 110. For example, a root user of client 120 may run an installation program that may install the daemon. The daemon may be configured to auto-start on client 120 boot so that connectivity with central authority 130 may be restored after a reboot, for example. Configuration data for the daemon (e.g., established through process 500 as described below) may be read and loaded upon auto-start.

Some embodiments may use alternatives to the access daemon. For example, some embodiments may use a separate machine that may be called and that may perform processing in order to obtain information on the caller. Some embodiments may use a multifactor authentication machine to receive authentication of the caller, for example. Some embodiments may use a specific OS module that performs similar processes. In any case, the daemon, machine, or module may obtain reliable information on the requesting entity for which access is governed as predefined in a policy. The daemon solution may be used because it may have access to information regarding the accessing process and user that it may retrieve from the operating system and/or because it may be difficult to spoof.

At 504, client 120 may configure the access daemon. For example, the root user may configure the daemon executable with policy and/or endpoint information. In some embodiments, multiple policies may be allowed, enabling the daemon to communicate with central authority 130 to provide access to a variety of services for one or more users and/or processes.

At 506, client 120 may register with central authority 130. For example, client 120 may communicate with central authority 130 for a first time (e.g., sending a request to register), and central authority 130 may establish a trust on first use (TOFU) relationship with client 120 based on a UUID of client 120. This first trust may be the basis for later usage of the authorization service from client 120. For example, as a response to the request to register, central authority 130 may send a secret to client 120 (e.g., a JSON web token (JWT) with a HMAC key in the payload).

TOFU may provide an underlying mechanism of trust that may establish specific trust in a particular machine for central authority 130. Some embodiments may use other options to establish trust, such as pre-assigning a secret to a daemon. Client 120 may register with central authority 130 using other types of secrets in other embodiments, such as passwords, symmetric keys, asymmetric keys, or any other kind of pre-shared secret that may be used for authentication purposes. Any option used may be required to establish trust in a dynamic (cloud) environment while maintaining a high level of security.

At 508, client 120 may store the registration data. For example, the daemon may store the secret in client 120 memory (e.g., in a config file accessible only to root, where the config file may include a JSON array with each object in the array containing the policy-id and the JWT received for that policy registration). In some embodiments, due to the TOFU arrangement, once the daemon registers, central authority 130 may disallow other registrations from the same client 120, and all credential requests (e.g., described below) may be required to go through the registered daemon. An application on client 120 may be required to communicate with the daemon in order to be authenticated and receive its access credentials. Any direct communication by the application with central authority 130 may fail if the daemon has already established trust.

Returning to FIG. 3B, at 308, central authority 130 may authenticate client 120. For example, central authority 130 may evaluate evidence in the request and may use its own and/or other resources to determine whether client 120 complies with policy rules.

For embodiments wherein the request includes a predefined string and/or an AWS identity document, central authority 130 may analyze the string and/or document for policy compliance. For example, central authority 130 may authenticate client 120 based on the access policy criteria by verifying that client 120 matches all criteria. The verifying may include comparing the contents of the string to the policy data stored in the central authority 130 database to determine whether the parameters match. The parameters may be signed and validated, so service provider 150 may be able to trust that they were not maliciously edited. For AWS access policies, the verifying may include comparing the contents of the document to the policy data stored in the central authority 130 database and additional data to determine whether the parameters match. The additional data may include external parameters. In order to determine these external parameters, central authority 130 may cause query system 140 to obtain the external parameters through network 110. For example, query system 140 may query AWS infrastructure API(s) related to client 120 and/or service provider 150 to gather details relevant to client's 120 compliance with the parameters. In a specific example, query system 140 may query an AWS API to determine whether an AWS document from client 120 signed by AWS is legitimate. In another specific example, query system 140 may query a private network 110 to which client 120 is connected to verify a private IP address reported by client 120. Another example parameter may include a “CreatedFor” field by which service provider 150 may identify the client 120 for which service provider 150 created the policy and may create a link between the policy and the authentication of this policy to its listing of clients 120. Another example parameter may include an “Opaque” field by which service provider 150 may store anything in theory, such as authorization data which may allow service provider 150 to receive not only validation of authority once client 120 identifies itself to central authority 130, but also to check what operations client 120 may be allowed to perform on the specific service provider 150. If the parameters match, central authority 130 may authenticate client 120. If one or more parameters do not match, central authority 130 may send a message to client 120 indicating client 120 cannot be authenticated based on the provided parameters.

For embodiments wherein client 120 uses the access daemon, central authority 130 may provide access credentials not only based on policy compliance but also based on the secret that was provided as described above. For example, when called by an application on client 120, the daemon may sign a request with a signing key from the secret. The daemon may also gather information on the process which called it. The information may be gathered by establishing a named pipe, which may then lead to the process ID and other relevant information describing the process and/or the user running the process. For example, the named pipe may be a Unix socket for local machine interactions. The named pipe may be accessible to all users for read and write. For example, the named pipe may be world-writeable and readable so that all users can write a request and read a response. The directories may be world-traversable so all users can reach the named pipe. Client 120 processes may communicate with the daemon using the named pipe in order to get central authority 130 credentials. Client 120 may send the signed request generated by the daemon to central authority 130 for obtaining access credentials. Central authority 130 may authenticate client 120 by determining that the secret in the signed request matches the expected secret in central authority 130 memory generated as described above. If the secret is correct and the parameters match, central authority 130 may authenticate client 120. If the secret is incorrect and/or one or more parameters does not match, central authority 130 may send a message to client 120 indicating client 120 cannot be authenticated based on the provided secret and/or parameters.

At 310, if client 120 has been authenticated at 308, central authority 130 may generate credentials for client 120. For example, an authenticated client 120 may send a request to central authority 130 for credentials for one or more service providers 150. In response, central authority 130 may generate signed temporary credentials in JWT format. The credentials may be generated with an expiration time and/or date. The credentials may include service proprietary data (if any) that may be associated with the access policy used to obtain the temporary credentials. For example, the proprietary data may be used for further authorization of client 120 by service provider 150 itself. Central authority 130 may send the credentials to client 120.

In some embodiments, the request may identify the service to which client 120 is requesting access within a JWT that may be signed by the client 120 private key. In embodiments wherein client 120 may have separate processes and/or users 125 who may be requesting access, client 120 may perform additional processing to generate the request. For example, the daemon may obtain information on the user and process (e.g., using linux syscalls). The daemon may generate a request with the following values, for example: user name, group name, process fullpath, user ID, group ID. In response, central authority 130 may generate signed temporary credentials in JWT format. The credentials may be generated with an expiration time and/or date. The credentials may include service proprietary data (if any) that may be associated with the access policy used to obtain the temporary credentials. For example, the proprietary data may be used for further authorization of client 120 by service provider 150 itself. Central authority 130 may send the credentials to client 120.

At 312, client 120 may request access to the service. For example, client 120 may send the credentials (e.g., the JWT) to service provider 150. Service provider 150 may send the credentials to central authority 130 for verification.

At 314, central authority 130 may validate the credentials sent by service provider 150. For example, central authority 130 may validate data in the JWT. If the policy does not include process and/or user level access requirements, central authority 130 may use the public key to verify the signature. If the policy contains user or process level entries, central authority 130 may use the public key to verify the signature and may also verify the user and/or process against the policy. If validated, central authority 130 may send a key for accessing service provider 150 to client 120 and/or may send a message to service provider 150 causing service provider 150 to provide access to client 120. If the signature is not validated, central authority 130 may notify client 120 and/or service provider 150 that access should be denied.

At 316, based on the validation at 314, service provider 150 may provide the service to client 120. In some embodiments, client 120 may include the temporary credentials in a header in every request to service provider 150. Service provider 150 may validate the temporary credentials by fetching the verification key from central authority 130 or by sending a validation request together with the temporary credentials to central authority 130 (e.g., by repeating processing at 314).

As the foregoing description illustrates, the disclosed systems and methods may provide centralized authentication and authorization of clients 120 for accessing remote services based on a variety of policies. For example, the same central authority 130 may validate different clients 120 for different services based on different policies. The elements of the system (e.g., central authority 130, client 120, and/or service provider 150) may be policy-agnostic (e.g., the policy may specify any terms and may even change over time, but the authentication and authorization may be performed similarly for all policies). This may result in an efficient, secure, and flexible authentication and authorization solution. Moreover, this may result in a flattening of communications between client 120 and service provider 150 (e.g., because service provider 150 and client 120 may not be required to exchange several authentication and authorization messages between one another) while still allowing for trustworthy authentication and authorization.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of authenticating a client and authorizing the client to access a service of a service provider, comprising:
receiving, at a processor of a central authority separate from the client and the service provider, an access request from the client, the access request identifying at least one of a client user and a client process;
evaluating, by the processor, the access request to determine that the at least one of the client user and the client process complies with an access policy for the service provider;
in response to determining that the at least one of the client user and the client process complies with the access policy, generating, by the processor, a credential including a key;
sending, by the processor, the credential to the client;
receiving, by the processor, the credential from the service provider;
validating, by the processor, the key included in the credential; and
in response to the validating, causing, by the processor, the service provider to provide the client with access to the service.

2. The method of claim 1, wherein the access request further identifies the service provider from among a plurality of service providers associated with the central authority.

3. The method of claim 2, wherein each of the plurality of service providers has a different access policy.

4. The method of claim 1, wherein:
the client user is one of a plurality of client users associated with the client; and
at least two of the plurality of client users have different access policies for the service provider.

5. The method of claim 1, wherein:
the client process is one of a plurality of client processes associated with the client; and
at least two of the plurality of client processes have different access policies for the service provider.

6. The method of claim 1, further comprising registering, by the processor, the service provider, the registering comprising establishing the central authority as an authentication and access authority for the service provider.

7. The method of claim 1, further comprising establishing, by the processor, the access policy.

8. The method of claim 7, wherein establishing the access policy includes specifying at least one policy rule and at least one allowed client user and/or at least one allowed client process.

9. The method of claim 1, wherein the evaluating includes determining that the at least one of the client user and the client process is an allowed client user and/or an allowed client process as specified by the access policy.

10. The method of claim 1, wherein the evaluating includes determining that the client complies with at least one policy rule as specified by the access policy.

11. The method of claim 1, wherein the causing includes sending a key for accessing the service provider to the client.

12. The method of claim 1, wherein the causing includes sending a message to the service provider causing the service provider to allow access by the client.

13. A system for authenticating a client and authorizing the client to access a service of a service provider, comprising:
a transceiver configured to communicate with a client and a service provider; and
a processor in communication with the transceiver, the processor being configured to perform processing comprising:
receiving, by the transceiver, an access request from the client, the access request identifying at least one of a client user and a client process;
evaluating the access request to determine that the at least one of the client user and the client process complies with an access policy for the service provider;
in response to determining that the at least one of the client user and the client process complies with the access policy, generating a credential including a key;
sending, by the transceiver, the credential to the client;
receiving, by the transceiver, the credential from the service provider;
validating the key included in the credential; and
in response to the validating, causing the service provider to provide the client with access to the service.

14. The system of claim 13, wherein the access request further identifies the service provider from among a plurality of service providers associated with the central authority.

15. The system of claim 14, wherein each of the plurality of service providers has a different access policy.

16. The system of claim 13, wherein:
the client user is one of a plurality of client users associated with the client; and
at least two of the plurality of client users have different access policies for the service provider.

17. The system of claim 13, wherein:
the client process is one of a plurality of client processes associated with the client; and
at least two of the plurality of client processes have different access policies for the service provider.

18. The system of claim 13, wherein the processing further comprises registering the service provider, the registering comprising establishing the central authority as an authentication and access authority for the service provider.

19. The system of claim 13, wherein the processing further comprises establishing the access policy.

20. The system of claim 19, wherein establishing the access policy includes specifying at least one policy rule and at least one allowed client user and/or at least one allowed client process.

21. The system of claim 13, wherein the evaluating includes determining that the at least one of the client user and the client process is an allowed client user and/or an allowed client process as specified by the access policy.

22. The system of claim 13, wherein the evaluating includes determining that the client complies with at least one policy rule as specified by the access policy.

23. The system of claim 13, wherein the causing includes sending, by the transceiver, a key for accessing the service provider to the client.

24. The system of claim 13, wherein the causing includes sending, by the transceiver, a message to the service provider causing the service provider to allow access by the client.
